(19) United States
(12) Patent Application Publication
(10) Pub. No.: US 2018/0137218 A1
(43) Pub. Date: May 17, 2018

(54) SYSTEMS AND METHODS FOR SIMILARITY-BASED INFORMATION AUGMENTATION

(71) Applicant: General Electric Company, Schenectady, NY (US)

(72) Inventors: Arun Karthi Subramaniyan, Clifton Park, NY (US); Ankur Srivastava, Chicago, IL (US); You Ling, Schenectady, NY (US); Natarajan Chennimalai Kumar, Schenectady, NY (US); Felipe Antonio Chegury Viana, Niskayuna, NY (US); Mahadevan Balasubramaniam, Ballston Lake, NY (US); Peter Eisenzopf, Altamont, NY (US)

(21) Appl. No.: 15/349,185

(22) Filed: Nov. 11, 2016

(51) Int. Cl. G06F 17/50; G06F 17/13

(52) U.S. Cl. CPC G06F 17/5009; G06F 17/13

(57) ABSTRACT

A system for similarity analysis-based information augmentation for a target component includes an information augmentation (IA) computer device. The IA computer device identifies a target component input variable with unavailable data. The IA computer device executes a similarity analysis function, identifying at least two test components with data for the input variable exceeding a threshold. The IA computer device generates parameter distributions for test data for each test component. The IA computer device generates model coefficients using the parameter distributions, determining a proportional mix of the parameter distributions. The IA computer device authors a predictive model configured to generate at least one predicted value for the target data for the at least one input variable for the target component by including the at least one model coefficient in the predictive model. The IA computer device generates, using the predictive model, the at least one predicted value.

### BACKGROUND

The field of the disclosure relates generally to information augmentation methods that use similarity analysis. More specifically, the present disclosure relates to systems and methods for determining missing or unknown data for a component using similarity analysis.

Any system, especially one involving specifically engineered components and/or a complex combination of parts, is subject to anticipated and potentially accelerated wear and a decrease in service life, including component failure. Such components are closely monitored for changes in performance. Each component is monitored for specific inputs (e.g., performance variables, external data such as ambient conditions, or the like). As advances in technology have led to the ability to retrieve accurate, real- or near real-time data from remotely located components, systems have been developed to leverage this data to provide improved predictive and modeling capabilities for performance of components. Thousands of variables may be required to accurately capture data generated by a complex component such as an aircraft engine or a turbine. In some scenarios, there is insufficient data available for a component. For example, data may not be available because it became corrupted in transit even though the data was validly generated. In other scenarios, data is not properly collected at all. This may be because certain sensors or other processes failed to perform at expected levels, or because an operator or stakeholder inadvertently or deliberately neglected to properly observe and measure the performance of a component.

Certain component management platforms (AMPs) tools and cloud computing techniques that enable the incorporation of a manufacturer's component knowledge with a set of development tools and best practices. However, known models for information augmentation often are limited by techniques that require large datasets. For example, some known predictive models are unable to correct for the fact that actual usage can be significantly different from design intent. As noted above, data availability and variability can be massive. Some known models are unable to account for large uncertainties in life possible due to small variations in operation. Additionally, the physics of component operation is complex and requires that the models used to measure and predict component operation be calibrated and honed over time.

### BRIEF DESCRIPTION

In one aspect, a system for similarity analysis-based information augmentation for a target component is provided. The system includes an information augmentation (IA) computer device in communication with a memory device and a processor. The IA computer device is configured to identify at least one input variable for a target component, where at least some target data for the at least one input variable is unavailable. The IA computer device is also configured to execute a similarity analysis function to identify a first test component and a second test component, where the first test component has first test data for the at least one input variable and the second test component has second test data for the at least one input variable, and where the first test data and the second test data each exceed a predefined completeness threshold. The IA computer device is further configured to generate a first parameter distribution using the first test data and a second parameter distribution using the second test data. The IA computer device is also configured to generate at least one model coefficient using the first parameter distribution and the second parameter distribution, where the IA computer device is further configured to determine a proportional mix of the first parameter distribution and the second parameter distribution. The IA computer device is further configured to author a predictive model configured to generate at least one predicted value for the target data for the at least one input variable for the target component, where the IA computer device is further configured to include the at least one model coefficient in the predictive model. The IA computer device is also configured to generate, using the predictive model, the at least one predicted value.

In another aspect, a method for information augmentation for a target component is provided. The method is implemented using an information augmentation (IA) computer device in communication with a memory device and a processor. The method includes identifying at least one input variable for a target component, where at least some target data for the at least one input variable is unavailable. The method also includes executing a similarity analysis function to identify a first test component and a second test component, where the first test component has first test data for the at least one input variable and the second test component has second test data for the at least one input variable, and where the first test data and the second test data each exceed a predefined completeness threshold. The method further includes generating a first parameter distribution using the first test data and a second parameter distribution using the second test data. The method also includes generating at least one model coefficient using the first parameter distribution and the second parameter distribution, where the IA computer device is further configured to determine a proportional mix of the first parameter distribution and the second parameter distribution. The method further includes authoring a predictive model configured to generate at least one predicted value for the target data for the at least one input variable for the target component, where the IA computer device is further configured to include the at least one model coefficient in the predictive model. The method also includes generating, using the predictive model, the at least one predicted value.

In yet another aspect, a computer readable medium having computer-executable instructions for information augmentation for a target component is provided. When executed by at least one processor, the computer-executable instructions cause the at least one processor to identify at least one input variable for a target component, where at least some target data for the at least one input variable is unavailable. The computer-executable instructions also cause the at least one processor to execute a similarity analysis function to identify a first test component and a second test component, where the first test component has first test data for the at least one input variable and the second test component has second test data for the at least one input variable, and where the first test data and the second test data each exceed a predefined completeness threshold. The computer-executable instructions further cause the at least one processor to generate a first parameter distribution using the first test data and a second parameter distribution using the second test data. The computer-executable instructions also cause the at least one processor to generate at least one model coefficient using the first parameter distribution and the second parameter distribution, where the IA computer device is further configured to determine a proportional mix of the first parameter distribution and the second parameter distribution. The computer-executable instructions further cause the at least one processor to author a predictive model configured to generate at least one predicted value for the target data for the at least one input variable for the target component, where the processor is further configured to include the at least one model coefficient in the predictive model. The computer-executable instructions further cause the at least one processor to generate, using the predictive model, the at least one predicted value.

### DRAWINGS

These and other features, aspects, and advantages will become better understood when the following detailed description is read with reference to the accompanying drawings in which like characters represent like parts throughout the drawings, where:

FIG. 1 is a simplified block diagram of an exemplary information augmentation (IA) computer device coupled with other computer devices;

FIG. 2 is a simplified block diagram of an exemplary configuration of a server system, including the IA computer device shown in FIG. 1;

FIGS. 3a and 3b are exemplary graphical displays showing how an information augmentation model is developed by IA computer device 10 (shown in FIG. 1) using test components;

FIG. 4 is a graphical display comparing two graphical overlays that of test components versus target components;

FIG. 5 is an example illustration showing how the IA computer device generates combined parameter distributions using multiple variables;

FIG. 6 shows an exemplary method for information augmentation for a target component; and

FIG. 7 is an exemplary configuration of a database within IA computer device 10 (shown in FIG. 1), along with other related computing components, that are used for information augmentation for a component.

Unless otherwise indicated, the drawings provided herein are meant to illustrate features of embodiments of the disclosure. These features are believed to be applicable in a wide variety of systems including one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “computer-readable media” includes all tangible, computer-readable media, including, without limitation, computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “processor” and “computer” and related terms, e.g., “processing device”, “computer device”, and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the terms “software” and “firmware” are interchangeable, and include any computer program stored in memory for execution by devices that include, without limitation, mobile devices, clusters, personal computers, workstations, clients, and servers.

As used herein, the term “predictive model” refers to computer code that, when executed, receives a set of input data and applies statistical or machine learning modeling techniques to that set of input data to predict an outcome. The term “predictive model” should further be understood to refer to analytics that result from training the predictive model using a set of input data according to a particular statistical or machine learning technique. As used herein, references to the process of “authoring” the predictive model should be understood to refer to process of selecting input data, features of the input data, measured outcomes, the desired analytical technique(s), whether the model is self-training, and other characteristics of the process by which the resulting analytic is generated and executes.

Computer systems, such as the information augmentation computer device are described, and such computer systems include a processor and a memory. However, any processor in a computer device referred to herein may also refer to one or more processors where the processor may be in one computer device or a plurality of computer devices acting in parallel. Additionally, any memory in a computer device referred to may also refer to one or more memories, where the memories may be in one computer device or a plurality of computer devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.” The term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above are only examples, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The present disclosure relates to information augmentation methods that use similarity analysis. More specifically, the present disclosure relates to systems and methods for determining missing or unknown data for a component using similarity analysis that is performed by an Information augmentation (IA) computer device. The IA computer device is configured to use similarity analysis to populate missing past data and also predict data for a component for which data is missing. Such a component is referred to herein as a “target component”. To generate data for the target component, the IA computer device makes use of data from one or more existing components that exhibit certain similarities to the target component. These other components are also notable in that data is available for these components, specifically the type of data that is missing for the target component. Such components are referred to herein as “test components”.

In one embodiment, the IA computer device is configured to identify one or more input variables for the target component. The example of an aircraft engine is used herein to illustrate this. More specifically, a commercial aircraft may have two aircraft engines, each with an identical specification and operating envelope. Using several different variables, data is collected for both aircraft engines. This data includes, for example, ambient temperature, atmospheric aerosol counts, internal engine temperature, or the like. However, internal engine temperature may not be collected for the port engine for a certain period of time, possibly due to a failed thermometer or heat sensing device. But internal engine temperature data is available for the starboard engine. Accordingly, the port engine can be considered a target component and the starboard engine can be considered a test component in this example. Internal engine temperature data from the starboard engine can be used to populate missing internal engine temperature data for the port engine using the techniques discussed below in greater detail. Additionally, other aircraft engines that operate under the same or similar conditions or have the same age and time in service can also be used as test components.

In at least some implementations, the IA computer device is configured to execute a similarity analysis function to identify a set of test components. In one embodiment, a similarity analysis function is selected from a library of functions that may include, without limitation, probability distribution functions, Bayesian Effect size functions, area metric functions, multi-dimensional distance functions, or the like. As noted above, there may be multiple aircraft engines with a service profile similar to that of the aircraft engine that is missing internal engine temperature data. Accordingly, to isolate a set of aircraft engines from which to determine the missing data, the IA computer device performs a similarity analysis using target component data that is available. For example, the IA computer device may determine that while a target component is missing internal engine temperature data, exhaust temperature data is available for that target component. Accordingly, the IA computer device compares exhaust temperature data for the target component against one or more test components to determine those test components that will be considered most similar for further analysis

In one embodiment, the IA computer device is configured to generate a histogram, line graph, or other graphical display using data from the target component and the one or more test components. The IA computer device is configured to graphically compare data for one variable (e.g., exhaust temperature) for the target component against data for the same variable for the target component. For example, the IA computer device is configured to overlay histograms for two components (one target, the other test) and determine an area metric for the graphical overlap. The IA computer device is configured to determine that the test component whose data exhibits greatest overlap is likely the most similar to the target component.

Once the test component or test components have been isolated, the IA computer device is configured to perform statistical analysis using the test data. For example, the IA computer device is configured to generate a first parameter distribution using the first test data and a second parameter distribution using the second test data. In one embodiment, the parameter distributions are not standard Gaussian distributions where a mean and a standard deviation of the distribution can be conveniently calculated. For example, the parameter distributions used include, without limitation, log-normal distributions, Gumbel distributions, Weibull distributions, or the like. Additionally, the IA computer device is configured to generate parameter distributions for multiple variables, not just a single variable (exhaust temperature) as described above. Accordingly, the generated parameter distributions will present an organized view of test data for the identified test components. Moreover, the IA computer device is configured to generate parameter distributions for just a thresholded space (i.e., a subset of the full data). For example, the IA computer device determines that internal engine temperature anomalies occur only during winter takeoffs for an aircraft engine. Accordingly, the IA computer device is configured to set a temperature threshold for the test component data and use only winter data. For example, the IA computer device may first query a database for test component data for certain calendar dates. The IA computer device may query the database using certain temperature observations from the test component itself that may indicate winter weather, or the like.

In one embodiment, random sample values are derived from the parameter distributions. More specifically, a predefined number of random samples is taken from parameter distributions from each test components. Even more specifically, the predefined number is governed by a proportion that is defined using the similarity analysis that is initially performed to isolate the test components that were used. For example, given a single target component, similarity analysis may produce two test components A and B that are very similar to the target component. In other words, certain test data resembles known target data for the target component. However, test data from component A may be, for example, twice as similar to the target data, compared to test data from component B. Accordingly, the IA computer device is configured to draw random samples using a proportion of similarity that is generated from the similarity analysis. In the above example, the IA computer device is configured to draw samples from the test data sets in a 2 to 1 (or 66.66% to 33.33%) proportion.

The IA computer device is configured to generate a final parameter distribution known as a coefficient parameter distribution using the abovementioned proportionate random samples. Accordingly, the coefficient parameter distribution represents one or more coefficients for a model equation or a set of complex functions that will be used to generate missing data for the target component. For example, a linear regression model with two predictor variables can be expressed with the following equation:

Y=B0+B1*X1+B2*X2+E Equation1.

The variables in the model are Y, the response variable; X1, the first predictor variable; X2, the second predictor variable; and E, the residual error, which is an unmeasured variable. The parameters in the model are B0, the Y-intercept; B1, the first regression coefficient; and B2, the second regression coefficient. Another example equation is provided below:

$$\frac{da}{dN} = {c ( Δ K )}^{n} . \qquad Equation 2$$

where a is a measure of length, N is a number of cycles, ΔK is the stress intensity factor increment in a particular cycle, and C and n are coefficients to be estimated.

Accordingly, the model, now augmented with coefficients from the similarity analysis, generates one or more data values for the target component. In one embodiment, the IA computer device is configured to enter certain additional parameter data (e.g., a timestamp that occurs in the past) into the model in order to generate missing past data for the target component. Additionally, the IA computer device is configured generate at least one predicted value in the future for the target data. The now-populated data from the past and predicted data for the future can be used by an operator to initiate a logistics process that modifies a maintenance plan for the target component at least partially based on the at least one predicted value. For example, the missing data may reveal to the operator that the target component has exceeded certain thresholds for normal operation (e.g., the determined internal engine temperature was too high, leading to component wear and decrease in service life).

For the purposes of this disclosure, a predictive model that is paired to a particular industrial component is referred to as a “digital twin” of that component. A given digital twin may employ multiple predictive models associated with multiple components or subcomponents of the component. In some scenarios, a digital twin of a particular component may include multiple predictive models for predicting different behaviors or outcomes for that component based on different sets of sensor data received from the component or from other sources. A predictive model or set of predictive models associated with a particular industrial component may be referred to as “twinned” to that component. A digital twin may comprise a mathematical representation or model along with a set of tuned parameters that describe the current state of the component.

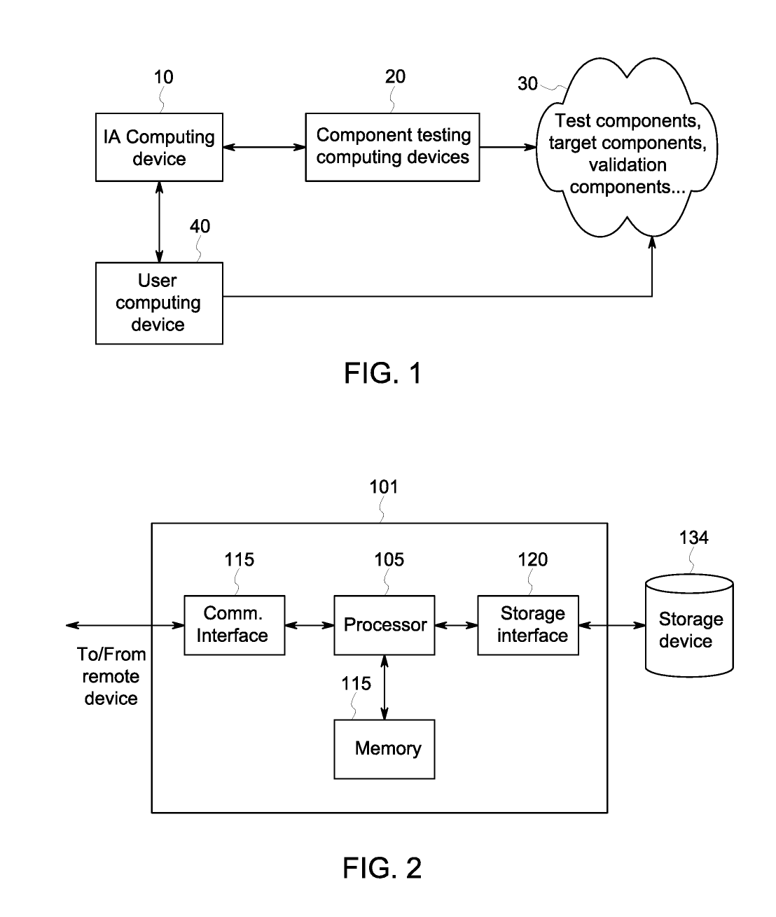

FIG. 1 is a simplified block diagram of an exemplary information augmentation (IA) computer device 10 coupled with other computer devices. IA computer device 10 is in communication with one or more component testing computer devices 20, and at least one user computer device 40. Component testing computer devices 20 are also coupled to a plurality of components 30. In one embodiment, component testing computer devices 20 are embedded with various physical components including, and without limitation, engine computers, machine sensors, embedded processors, and the like. In another embodiment, such component testing computer devices 20 are separate from the actual component to be tested, but receive and record testing data for each component including, and without limitation, temperature data, crack length data, and the like. Components 30 include test components, i.e., those used to develop information augmentation models, target components, i.e., those to which information augmentation models are applied in order to issue predictions for the target components, and validation components, i.e., those that are used to validate the information augmentation models.

In one embodiment, IA computer device 10 receives component data from component testing computer devices 20 and develops information augmentation models as described above. User computer device 40 sends a prompt or signal to IA computer device 10 to develop an information augmentation model, request component data, or issue a prediction for a component. IA computer device 10 develops and applies an information augmentation model, generates predictions regarding the future target data for a target component, and transmits the prediction(s) to user computer device 40.

FIG. 2 is a simplified block diagram of an exemplary configuration of a server system 101, including IA computer device 10 (shown in FIG. 1). Server system 101 includes a processor 105 for executing instructions. Instructions are stored in a memory area 110, for example. Processor 105 includes one or more processing units, e.g., and without limitation, in a multi-core configuration for executing instructions. The instructions may be executed within a variety of different operating systems on the server system 101, such as UNIX, LINUX, Microsoft Windows®, and the like. The algorithms can also be executed on massively parallel infrastructure such as Hadoop and Spark. More specifically, the instructions may cause various data manipulations on data stored in storage 134, e.g., and without limitation, create, read, update, and delete procedures. It should also be appreciated that upon initiation of a computer-based method, various instructions may be executed during initialization. Some operations may be required in order to perform one or more processes described herein, while other operations may be more general and/or specific to a particular programming language, e.g., and without limitation, C, C#, C++, Java, or other suitable programming languages, and the like.

Processor 105 is operatively coupled to a communication interface 115 such that server system 101 is capable of communicating with a remote device such as a user system or another server system 101. For example, communication interface 115 receives communications from user computer devices and test computer devices via the Internet.

Processor 105 is also operatively coupled to a storage device 134. Storage device 134 is any computer-operated hardware suitable for storing and/or retrieving data. In some embodiments, storage device 134 is integrated in server system 101. In other embodiments, storage device 134 is external to server system 101. For example, server system 101 may include one or more hard disk drives as storage device 134. In other embodiments, storage device 134 is external to server system 101 and may be accessed by a plurality of server systems 101. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 105 is operatively coupled to storage device 134 via a storage interface 120. Storage interface 120 is any component capable of providing processor 105 with access to storage device 134. Storage interface 120 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 105 with access to storage device 134.

Memory area 110 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

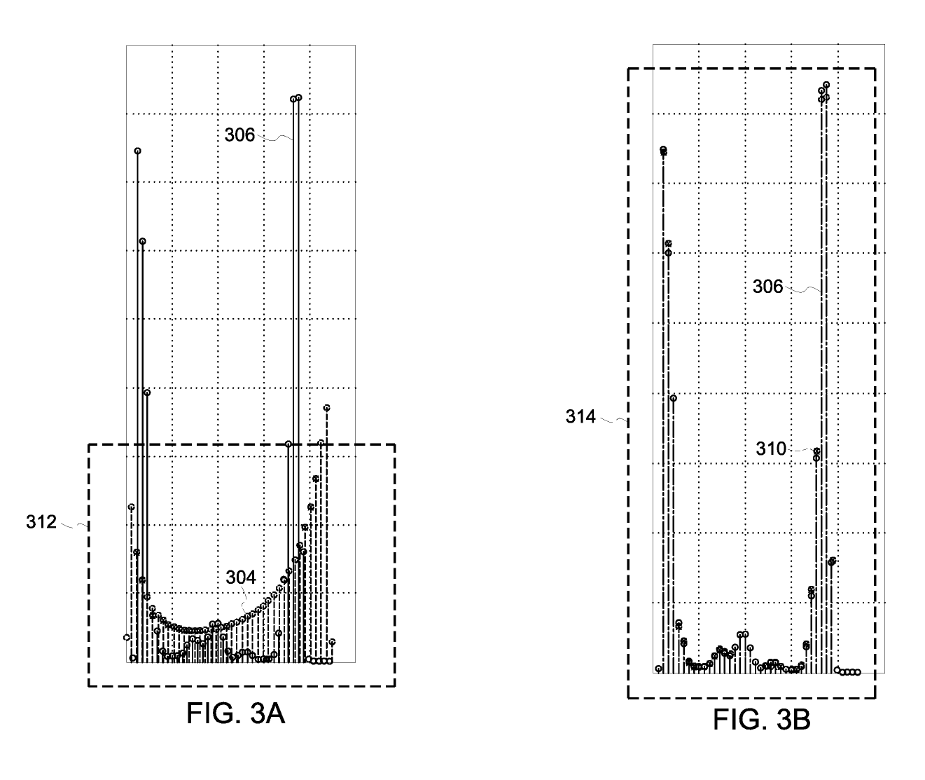

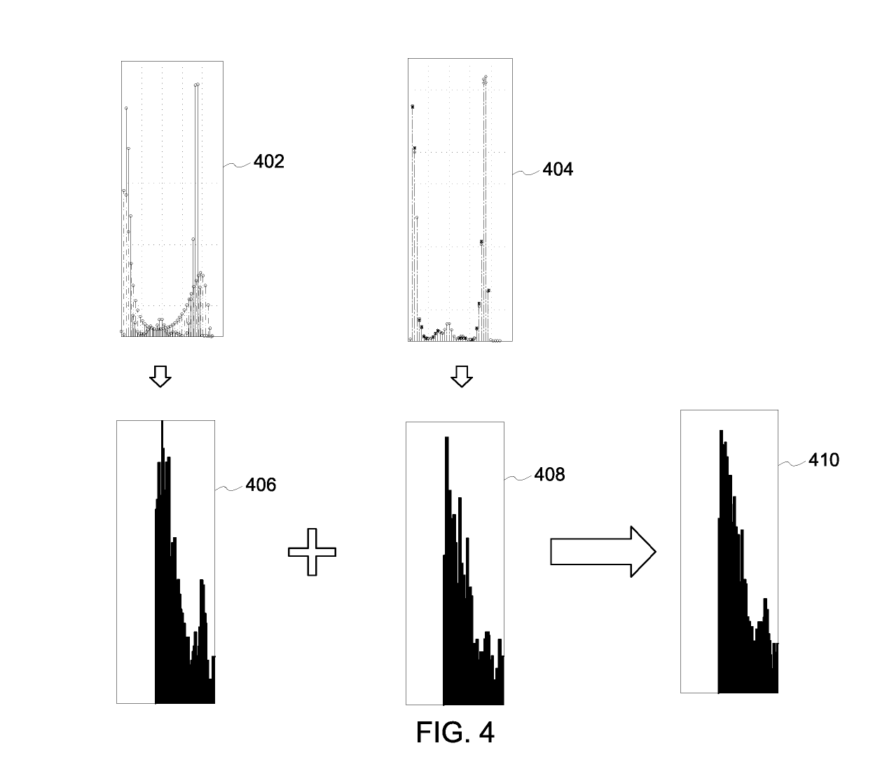

FIGS. 3a and 3b are exemplary graphical displays showing how an information augmentation model is developed by IA computer device 10 (shown in FIG. 1) using test components. In one embodiment, IA computer device 10 receives test data from test components and target data from the target component. The graphical displays are generated using data that is available for both the test component and the target component in order to generate the validation test component as explained in greater detail below with respect to FIG. 4. The validation test component will be used to generate coefficients for a model that will output target data that is not available for the target component. For example, the graphical displays in FIGS. 3a and 3b are created using test data and target data for an amount of a measured quantity measured by a sensor on an aircraft engine during normal operation. In the exemplary embodiment, test data and target data are available for variable 1 (i.e., the measured quantity) and test data is available for variable 2 (internal engine temperature) but target data is not available for variable 2.

As shown, IA computer device 10 generates a histogram plot for each set of data and generates overlays in order to determine the degree of overlap. In FIG. 3a, histogram 304 represents test data from a test component A. Histogram 306 represents target data from a target component. Also, area metric 312 represents an area of overlap between histogram 304 and histogram 306 in FIG. 3a. FIG. 3a shows that there is not a great degree of overlap between the coarse aerosol test data for test component A versus the target component. Additionally, FIGS. 3a and 3b highlight the area of overlap using ‘x’ marks.

FIG. 3b shows histogram 306, which is the same histogram as in FIG. 3a (i.e., coarse aerosol data for a target component). FIG. 3b additionally shows a histogram 310, which represents test data (coarse aerosol data) for a test component B. Additionally, FIG. 3b shows area metric 314 which represents an area of overlap between histogram 306 and histogram 310. Compared to area metric 312, area metric 314 shows a much larger degree of overlap between the data for test component B and that for the target component. As a result, it is presumable that test component B is more similar to the target component than is test component A.

FIG. 4 is a graphical display comparing two graphical overlays of test components versus target components. IA computer device 10 (as shown in FIG. 1) combines test data from two test components in order to generate a validation test component that will be used to generate coefficients for a model. To achieve this, IA computer device 10 generates a number of graphical overlays to determine which test component is more similar to the target component. IA computer device 10 generates these graphical overlays with respect to known data dimensions (i.e., variables for which there is data available both for the test component and target component) and determines respective amounts so that proper weights can be computed for generating target coefficient distributions. This is shown in FIGS. 3a and 3b.

As shown in FIG. 4, graphical display 402 and graphical display 404 are derived from FIGS. 3a and 3b respectively. Graphical display 402 is an overlay where the test component is not very similar to the target component. Graphical display 404 is an overlay where the test component shows greater similarity to the target component. Accordingly, IA computer device 10 generates a parameter distribution 406 from graphical display 402 and a parameter distribution 408 from graphical display 404. Parameter distributions 406 and 408 are combined with specific weights to generate a validation parameter distribution 410 that is used to generate model coefficients. As shown in FIG. 4, these parameter distributions 406 and 408 model coefficients that were estimated by training the models individually. The probability distributions in FIG. 3a and FIG. 3b correspond to the input variables.

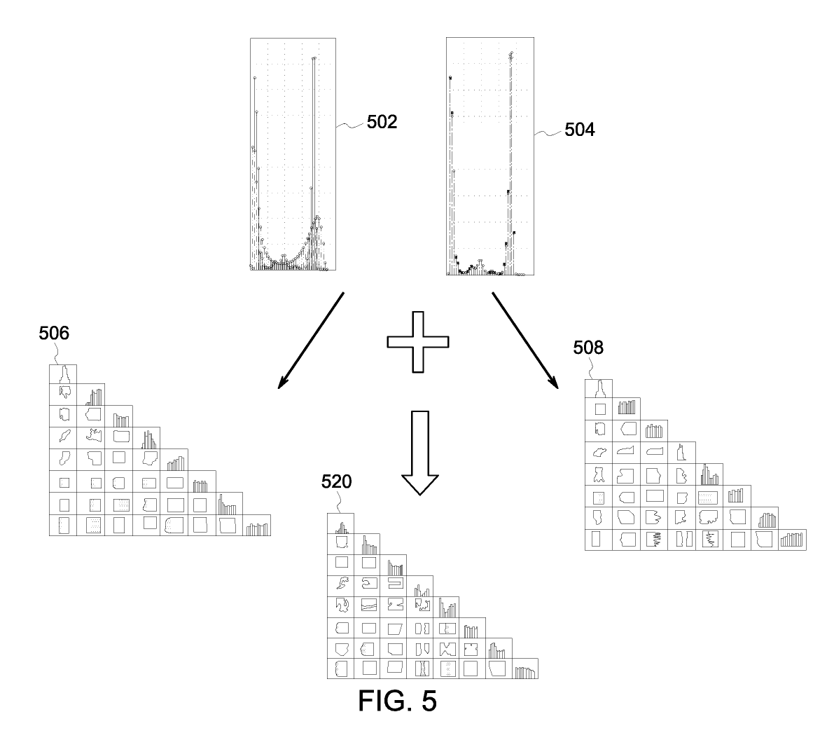

FIG. 5 is an example illustration showing how IA computer device 10 generates combined parameter distributions using multiple variables. FIG. 5 shows that graphical displays 502 and 504 (similar to graphical displays 402 and 404, shown in FIG. 4) result in parameter distributions being created for the two test components being analyzed. However, now the parameter distributions are created for multiple variables and use multiple techniques, not just graphical overlays. Mixed parameter distributions can be computed using a variety of techniques such as multi-dimensional distance techniques, area metric methods, probabilistic distance methods, or the like. Moreover, the parameter distributions in FIG. 4 were using just a single variable to determine similarity of two test components to the target component. The similarity caused the IA computer device 10 to select these two components for further analysis. By contrast, the parameter distributions in FIG. 5 are now being generated for, for example, multiple available variables. For example, the parameter distribution sets of FIG. 5 for an aircraft engine will be generated for variables such as exhaust temperature, electrical current level, corrosion levels of various components, crack lengths, physical deviation levels for components, or the like.

As shown in FIG. 5, parameter distribution set 506 is generated for a test component that showed little similarity to the target component (corresponding to graphical display 502), while parameter distribution set 508 is generated for a test component that showed somewhat greater similarity to the target component (corresponding to graphical display 508). In one embodiment, parameter distribution sets 506 and 508 are not standard Gaussian distributions that can be represented using their mean and/or standard deviation. Accordingly, a random sampling method is used to gain an accurate representation of the data in parameter distribution sets 506 and 508.

Additionally, the random sampling is not done equally for both test components. In one embodiment, the sampling is done according to a degree of similarity to the target component, as described earlier. Once the random samples are determined, IA computer device 10 combines the two random sample sets to generate a validation parameter distribution 520 that is used to generate coefficients for a statistical model that will predict missing and future data for the target component.

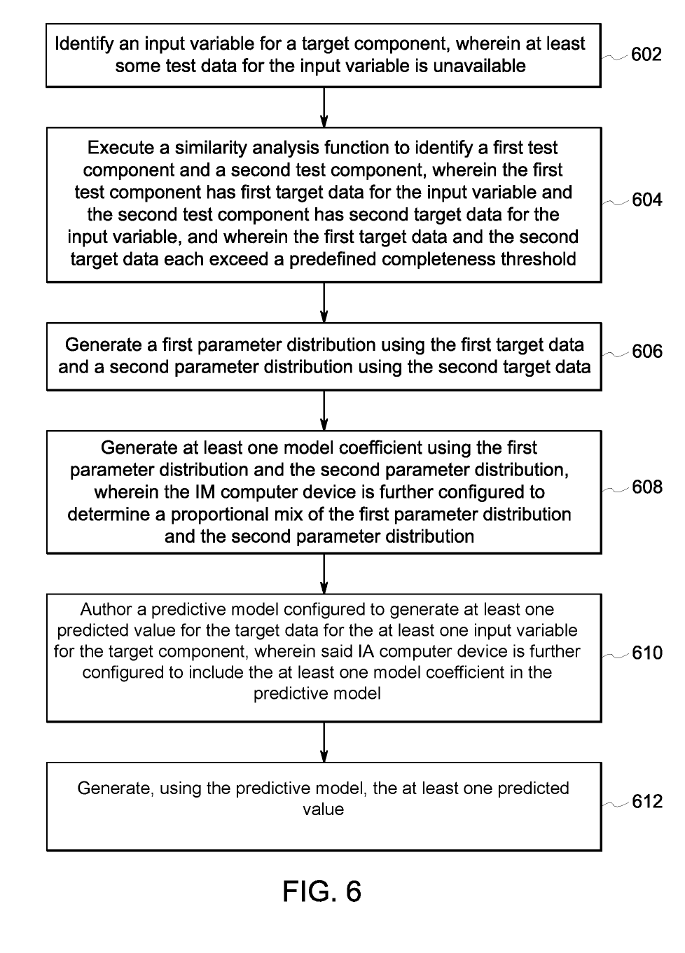

FIG. 6 shows an exemplary method for information augmentation for a target component. IA computer device 10 (shown in FIG. 1) identifies 602 an input variable for a target component, wherein at least some target data for the input variable is unavailable. In one embodiment, IA computer device 10 is configured to perform statistical analysis on a plurality of target components to determine a target component that has the greatest amount of missing data. For example, IA computer device 10 may query a database storing the target component data to determine a target component that has the greatest number of empty rows, or the greatest number of empty columns, or a combination of these. IA computer device 10 is configured to identify a target component based on configuration settings provided by an operator. For example, an operator may wish to identify target components that are missing specific types of data (e.g., all aircraft engines with no coarse aerosol count data). The operator may prompt IA computer device 10 accordingly to query for specific target components. The identified target component will have partially or wholly missing data for at least one variable.

IA computer device 10 is configured to execute 604 a similarity analysis function to identify one or more test components. In one embodiment, IA computer device 10 is configured to determine one or more metadata variables that represent the target component and query a database for test components with similar metadata variables (e.g., aircraft engines that fly the same route as the target aircraft engine, or aircraft engines of the same age or same specification as the target aircraft engine, or the like.) Once test components bearing similar metadata are isolated, IA computer device 10 is configured to determine that these test components have a set of data for the at least one variable that is partially or wholly missing for the target component. IA computer device 10 is configured to first analyze the test component data set to ensure that it exceeds a predefined threshold of quantity. For example, the test component may need to have 100% data for a certain time period. In one embodiment, IA computer device 10 selects at least two test components that have a sufficient quantity of data.

Given the two selected test components, IA computer device 10 is configured to generate 606 a first parameter distribution using the first test data and a second parameter distribution using the second test data. IA computer device 10 is further configured to generate at least one model coefficient using the first parameter distribution and the second parameter distribution, Additionally, IA computer device 10 is further configured to determine a proportional mix of the first parameter distribution and the second parameter distribution, as described above with respect to FIG. 5.

The proportional mix of random samples (as in FIG. 5) is then applied by the IA computer device 10 to generate 608 one or more model coefficients. IA computer device 10 is further configured to author 610 a predictive model configured to generate at least one predicted value for the target data for the at least one input variable for the target component. In one embodiment, IA computer device is configured to include the one or more model coefficients in the predictive model. Using the predictive model, IA computer device 10 is further configured to generate 612, using the predictive model, the at least one predicted value.

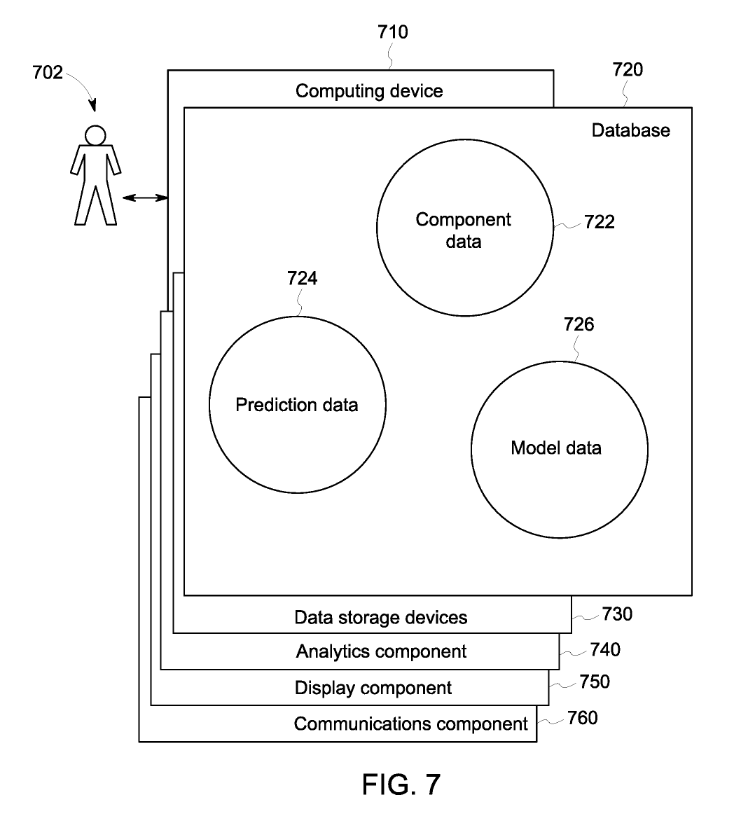

FIG. 7 is an exemplary configuration of a database within IA computer device 10 (shown in FIG. 1), along with other related computing components, that are used for information augmentation for a component. In some embodiments, computer device 710 is similar to IA computer device 10. User 702 (such as an owner of a component) accesses computer device 710 in order to augment information for a component. In some embodiments, database 720 is similar to storage device 134 (shown in FIG. 1). In the exemplary embodiment, database 720 includes component data 722, prediction data 724, and model data 726. Component data 722 includes data regarding each component, e.g., and without limitation, component identifiers, service life stage, component owner(s), associated service model identifier, and the like. Prediction data 724 includes data about predictions for each component, e.g., and without limitation, predicted repair date, predicted scrap date, and the like. Model data 726 includes parameter distribution data, coefficient data, model calibration data, and the like.

Computer device 710 also includes data storage devices 730. Computer device 710 also includes analytics component 740 that processes component data received from various component testing computer devices and from user computer devices at least in order to augment information for the component. Computer device 710 also includes display component 750 that receives prediction data from analytics component 740 and converts it into various formats in order to provide predictions compatible with a variety of user computer devices. Computer device 710 also includes communications component 760 which is used to communicate with user computer devices and component test computer devices using predefined network protocols such as TCP/IP (Transmission Control Protocol/Internet Protocol) over the Internet.

The methods and systems described herein may be implemented using computer programming or engineering techniques including computer software, firmware, hardware, or any combination or subset thereof, where the technical effects may be achieved by performing at least one of the following steps: TBD.

The above-described information augmentation systems and methods overcome a number of deficiencies associated with known systems and methods of information augmentation. Specifically, the above-described systems and methods perform a variety of similarity analysis functions in order to accurately identify test components that can be used to generate missing data for a target component. Unlike some known methods, each operational component and component is individually modeled, and parameter distributions predicting future values for multiple physical variables are processed by an information augmentation computer device that then populates missing past data and predicts future data for a target component.

An exemplary technical effect of the methods, systems, and apparatus described herein includes at least one of: (i) enabling built-in model quality assessment, allowing an information augmentation model to be calibrated and “trained” dynamically; (ii) ability to quantify how similar a target component is to a given test component; (iii) ability to identify changes in component configurations by analyzing operation at different time points; (iv) ability to utilize similarity analysis to “mix” the model parameters; (v) ability to check consistency of component configuration data by checking whether units with similar configuration perform similarly; and (vi) “smart” contract enforcement whereby populating missing data enables component providers to check whether their components are being used within service level agreement parameters.

Exemplary embodiments of information augmentation computer systems for information augmentation for a target component are described above in detail. The information augmentation computer systems, and methods of operating such systems are not limited to the specific embodiments described herein, but rather, components of systems and/or steps of the methods may be utilized independently and separately from other components and/or steps described herein. For example, the systems and methods may also be used in combination with other systems requiring information augmentation for a target component, and are not limited to practice with only the facilities, systems and methods as described herein. Rather, the exemplary embodiment can be implemented and utilized in connection with many other modeling applications that are configured to augment information for a component.

Some embodiments involve the use of one or more electronic or computer devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for similarity analysis-based information augmentation for a target component, said system comprising an information augmentation (IA) computer device in communication with a memory device and a processor, said IA computer device configured to:
identify at least one input variable for the target component, wherein at least some target data for the at least one input variable is unavailable;
execute a similarity analysis function to identify a first test component and a second test component, wherein the first test component has first test data for the at least one input variable and the second test component has second test data for the at least one input variable, and wherein the first test data and the second test data each exceed a predefined completeness threshold;
generate a first parameter distribution using the first test data and a second parameter distribution using the second test data;
generate at least one model coefficient using the first parameter distribution and the second parameter distribution, wherein said IA computer device is further configured to determine a proportional mix of the first parameter distribution and the second parameter distribution;
author a predictive model configured to generate at least one predicted value for the target data for the at least one input variable for the target component, wherein said IA computer device is further configured to include the at least one model coefficient in the predictive model; and
generate, using the predictive model, the at least one predicted value.

2. The system in accordance with claim 1, wherein said IA computer device is further configured to:
determine a metadata variable for the target component, wherein the metadata variable represents metadata for the target component, and wherein metadata includes a component type, a component service profile, and a component age; and
identify that the metadata variable is associated with the first test component and the second test component.

3. The system in accordance with claim 1, wherein said IA computer device is further configured to generate the proportional mix by using similarity analysis to determine a degree of similarity of the first parameter distribution and the second parameter distribution with a target parameter distribution of the target component.

4. The system in accordance with claim 1, wherein said IA computer device is further configured to generate the proportional mix by selecting a first random sample from the first parameter distribution and a second random sample from the second parameter distribution.

5. The system in accordance with claim 1, wherein said IA computer device is further configured to:
generate a first test data graphical representation using at least one other input variable of the first test data, a second test data graphical representation using the at least one other input variable of the second test data, and a target data graphical representation using the at least one other input variable of the target data, wherein the target data is available for the at least one other input variable;
graphically overlay the first test data graphical representation and second test data graphical representation over the target component graphical representation;
calculate a first degree of graphical overlap between the first test data graphical representation and the target component graphical representation, and a second degree of graphical overlap between the second test data graphical representation and the target component graphical representation; and
determine that the first test component is more similar to the target component compared to the second test component, based on a determination that the first degree of graphical overlap exceeds the second degree of graphical overlap.

6. The system in accordance with claim 1, wherein said IA computer device is further configured to execute the similarity analysis function in a thresholded space, wherein the thresholded space represents a subset of the target data.

7. The system in accordance with claim 1, wherein said IA computer device is further configured to select the statistical model from a plurality of statistical models based, at least in part, on an operator input providing one or more of the at least one input variable and a data query type, and wherein the data query type includes one or more of: a data anomaly, an extent of missing data, and a data trend.

8. A method for information augmentation for a target component, said method implemented using an information augmentation (IA) computer device in communication with a memory device and a processor, said method comprising:
identifying at least one input variable for the target component, wherein at least some target data for the at least one input variable is unavailable;
executing a similarity analysis function to identify a first test component and a second test component, wherein the first test component has first test data for the at least one input variable and the second test component has second test data for the at least one input variable, and wherein the first test data and the second test data each exceed a predefined completeness threshold;
generating a first parameter distribution using the first test data and a second parameter distribution using the second test data;
generating at least one model coefficient using the first parameter distribution and the second parameter distribution, wherein said IA computer device is further configured to determine a proportional mix of the first parameter distribution and the second parameter distribution;
authoring a predictive model configured to generate at least one predicted value for the target data for the at least one input variable for the target component, wherein said IA computer device is further configured to include the at least one model coefficient in the predictive model; and
generating, using the predictive model, the at least one predicted value.

9. The method in accordance with claim 8, further comprising:
determining a metadata variable for the target component, wherein the metadata variable represents metadata for the target component, and wherein metadata includes a component type, a component service profile, and a component age; and
identifying that the metadata variable is associated with the first test component and the second test component.

10. The method in accordance with claim 8, further comprising generating the proportional mix by using similarity analysis to determine a degree of similarity of the first parameter distribution and the second parameter distribution with a target parameter distribution of the target component.

11. The method in accordance with claim 8, further comprising generating the proportional mix by selecting a first random sample from the first parameter distribution and a second random sample from the second parameter distribution.

12. The method in accordance with claim 8, further comprising:
generating a first test data graphical representation using at least one other input variable of the first test data, a second test data graphical representation using the at least one other input variable of the second test data, and a target data graphical representation using the at least one other input variable of the target data, wherein the target data is available for the at least one other input variable;
graphically overlaying the first test data graphical representation and second test data graphical representation over the target component graphical representation;
calculating a first degree of graphical overlap between the first test data graphical representation and the target component graphical representation, and a second degree of graphical overlap between the second test data graphical representation and the target component graphical representation; and
determining that the first test component is more similar to the target component compared to the second test component, based on a determination that the first degree of graphical overlap exceeds the second degree of graphical overlap.

13. The method in accordance with claim 8, further comprising executing the similarity analysis function in a thresholded space, wherein the thresholded space represents a subset of the target data.

14. The method in accordance with claim 8, further comprising selecting the statistical model from a plurality of statistical models based, at least in part, on an operator input providing one or more of the at least one input variable and a data query type, and wherein the data query type includes one or more of: a data anomaly, an extent of missing data, and a data trend.

15. A computer readable medium having computer-executable instructions embodied thereon for information augmentation for a target component, wherein when executed by at least one processor, the computer-executable instructions cause the at least one processor to:
identify at least one input variable for the target component, wherein at least some target data for the at least one input variable is unavailable;
execute a similarity analysis function to identify a first test component and a second test component, wherein the first test component has first test data for the at least one input variable and the second test component has second test data for the at least one input variable, and wherein the first test data and the second test data each exceed a predefined completeness threshold;
generate a first parameter distribution using the first test data and a second parameter distribution using the second test data;
generate at least one model coefficient using the first parameter distribution and the second parameter distribution, wherein said IA computer device is further configured to determine a proportional mix of the first parameter distribution and the second parameter distribution;
author a predictive model configured to generate at least one predicted value for the target data for the at least one input variable for the target component, wherein said IA computer device is further configured to include the at least one model coefficient in the predictive model; and
generate, using the predictive model, the at least one predicted value.

16. The computer readable medium in accordance with claim 15, wherein the computer-executable instructions further cause the at least one processor to:
determine a metadata variable for the target component, wherein the metadata variable represents metadata for the target component, and wherein metadata includes a component type, a component service profile, and a component age; and
identify that the metadata variable is associated with the first test component and the second test component.

17. The computer readable medium in accordance with claim 15, wherein the computer-executable instructions further cause the at least one processor to generate the proportional mix by selecting a first random sample from the first parameter distribution and a second random sample from the second parameter distribution.

18. The computer readable medium in accordance with claim 15, wherein the computer-executable instructions further cause the at least one processor to generate the proportional mix by selecting a first random sample from the first parameter distribution and a second random sample from the second parameter distribution.

19. The computer readable medium in accordance with claim 15,
wherein the computer-executable instructions further cause the at least one processor to generate a first test data graphical representation using at least one other input variable of the first test data, a second test data graphical representation using the at least one other input variable of the second test data, and a target data graphical representation using the at least one other input variable of the target data, wherein the target data is available for the at least one other input variable;
graphically overlay the first test data graphical representation and second test data graphical representation over the target component graphical representation;
calculate a first degree of graphical overlap between the first test data graphical representation and the target component graphical representation, and a second degree of graphical overlap between the second test data graphical representation and the target component graphical representation; and
determine that the first test component is more similar to the target component compared to the second test component, based on a determination that the first degree of graphical overlap exceeds the second degree of graphical overlap.

20. The computer readable medium in accordance with claim 15, wherein the computer-executable instructions further cause the at least one processor to execute the similarity analysis function in a thresholded space, wherein the thresholded space represents a subset of the target data.
